(19) United States
(12) Patent Application Publication
(10) Pub. No.: US 2026/0317189 A1
(43) Pub. Date: Oct. 15, 2026

(54) ANTIPEROVSKITE COMPOSITIONS AND METHODS OF USE THEREOF

(71) Applicant: ARIZONA BOARD OF REGENTS ON BEHALF OF ARIZONA STATE UNIVERSITY, Scottsdale, AZ (US)

(72) Inventors: Nicholas ROLSTON, Phoenix, AZ (US); Mohammed SAHAL, Tempe, AZ (US); Gabriel ADAMS, Mesa, AZ (US)

(21) Appl. No.: 19/476,424

(22) PCT Filed: Apr. 19, 2024
(86) PCT No.: PCT/US24/25463

§ 371 Date: Oct. 17, 2025

Related U.S. Application Data
(60) Provisional application No. 63/461,132, filed on Apr. 21, 2023.

(51) Int. Cl. C01D 15/10; H01M 10/0525; H01M 10/0562

(52) U.S. Cl. CPC C01D 15/10; H01M 10/0525; H01M 10/0562; C01P 2006/40; H01M 2300/0068

(57) ABSTRACT

The present disclosure encompasses antiperovskite compositions, methods of making antiperovskite compositions, and methods of use thereof.

This application is an International Application claiming priority to U.S. Provisional Application No. 63/461,132, filed on Apr. 21, 2023, the entire contents of which are incorporated herein.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The present disclosure encompasses antiperovskite compositions, methods of making antiperovskite compositions, and methods of use thereof.

### BACKGROUND OF THE INVENTION

Currently, lithium-ion batteries use flammable and bulky liquid electrolytes, reducing energy density and safety of battery cells. Additionally, other solid-state electrolytes have required very high-cost, low throughput processing to manufacture.

### SUMMARY OF THE INVENTION

Aspects of the invention are drawn towards a halogen-free, lithium-rich antiperovskite composition (LiRAP) of Formula (I):

Li₃BA (Formula I)
wherein B is an anion selected from the group consisting of O⁻², Se⁻², or S⁻²; and A is an anion selected from the group consisting of NO₃⁻¹, NO₂⁻¹, CH₃⁻¹, or NH₂⁻¹; or Formula (II):

Li₂BA (Formula II)

wherein B is an anion selected from the group consisting of OH⁻, SeH⁻¹, and SH⁻; and A is an anion selected from the group consisting of NO₃⁻¹, NO₂⁻¹, CH₃⁻¹, or NH₂⁻¹. In embodiments, the composition comprises an ion conductivity of above about 1.0×10⁻⁴ S/cm, about 1.0×10⁻⁴ S/cm, about 0.9×10⁻⁴ S/cm, about 0.8×10⁻⁴ S/cm, about 0.7×10⁻⁴ S/cm, about 0.6×10⁻⁴ S/cm, about 0.5×10⁻⁴ S/cm, about 0.4×10⁻⁴ S/cm, about 0.3×10⁻⁴ S/cm, about 0.2×10⁻⁴ S/cm, about 1×10⁻⁵ S/cm, about 0.9×10⁻⁵ S/cm, about 0.8×10⁻⁵ S/cm, about 0.7×10⁻⁵ S/cm, about 0.6×10⁻⁵ S/cm, about 0.5×10⁻⁵ S/cm, about 0.4×10⁻⁵ S/cm, about 0.3×10⁻⁵ S/cm, about 0.2×10⁻⁵, S/cm, about 1.0×10⁻⁶ S/cm, about 4.07×10⁻⁶ S/cm, about 3.12×10⁻⁶ S/cm, about 1.15×10⁻⁷ S/cm, or below about 1.15×10⁻⁷ S/cm. In embodiments, the composition is selected from the group consisting of Li₃ONO₃, Li₃SNO₃, Li₃ONO₂, Li₃ONH₂, Li₃SNO₃, Li₂OHNO₃, Li₂OHNO₂, Li₂OHNH₂, Li₂SHNO₃, Li₂SHNO₂, Li₂SHNH₂, Li₃SeNO₃, Li₃SeNO₂, Li₃SeNH₂, Li₃SeCH₃, Li₂SeHNO₃, Li₂SeHNH₂, Li₂SeHCH₃, Li₂SeHNO₂, or any combination thereof. In embodiments, the composition is phase-stable at room temperature. In embodiments, the composition comprises one or more dopants.

Aspects of the disclosure are drawn towards a method of producing a halogen-free, solid-state electrolyte, the method comprising: dissolving lithium precursors in a solvent to form a solution; applying the solution onto a substrate; and drying the solution, thereby producing a halogen-free, solid-state electrolyte. In embodiments, the lithium precursors are selected from the group consisting of lithium hydroxide (LiOH), lithium acetate (C₂H₃LiO₂), lithium carbonate (Li₂CO₃), lithium oxide (Li₂O), lithium sulfanide (LiSH), lithium sulfide (Li₂S), lithium nitrate (LiNO₃), lithium nitrite (LiNO₂), or lithium amide (LiNH₂), lithium methoxide (LiCH₃O), lithium ethoxide (C₂H₅LiO), lithium isopropoxide (C₃H₇LiO), lithium tert-butoxide (LiOC(CH₃)₃, or any combination thereof. In embodiments, the lithium precursors are lithium nitrate (LiNO₃) and lithium oxide (Li₂O). In embodiments, the solid state-electrolyte is a film. In embodiments, the film has a thickness of about 10 nm to about 1 mm. In embodiments, the solvent comprises ethanol. In embodiments, the substrate comprises a silicon wafer, copper, stainless steel, aluminum, lithium, or any combination thereof. In embodiments, the film is coated onto an anode layer, a cathode layer, or both. In embodiments, drying the film comprises subjecting the film to a temperature of about 70° C. to about 350° C. In embodiments, the method does not require sintering. In some embodiments, the method further comprises sintering the solid-state electrolyte. In embodiments, the method is performed in an open-air environment or in a glovebox. In embodiments, the solid-state electrolyte comprises an ionic conductivity of above about 1.0×10⁻⁴ S/cm, about 1.0×10⁻⁴ S/cm, about 0.9×10⁻⁴ S/cm, about 0.8×10⁻⁴ S/cm, about 0.7×10⁻⁴ S/cm, about 0.6×10⁻⁴ S/cm, about 0.5×10⁻⁴ S/cm, about 0.4×10⁻⁴ S/cm, about 0.3×10⁻⁴ S/cm, about 0.2×10⁻⁴ S/cm, about 1×10⁻⁵ S/cm, about 0.9×10⁻⁵ S/cm, about 0.8×10⁻⁵ S/cm, about 0.7×10⁻⁵ S/cm, about 0.6×10⁻⁵ S/cm, about 0.5×10⁻⁵ S/cm, about 0.4×10⁻⁵ S/cm, about 0.3×10⁻⁵ S/cm, about 0.2×10⁻⁵, S/cm, about 1.0×10⁻⁶ S/cm, about 4.07×10⁻⁶ S/cm, about 3.12×10⁻⁶ S/cm, about 1.15×10⁻⁷ S/cm, or below about 1.15×10⁻⁷ S/cm. In embodiments, the solid-state electrolyte is selected from the group consisting of Li₃ONO₃, Li₃SNO₃, Li₃ONO₂, Li₃ONH₂, Li₃SNO₃, Li₂OHNO₃, Li₂OHNO₂, Li₂OHNH₂, Li₂SHNO₃, Li₂SHNO₂, Li₂SHNH₂, Li₃SeNO₃, Li₃SeNO₂, Li₃SeNH₂, Li₃SeCH₃, Li₂SeHNO₃, Li₂SeHNH₂, Li₂SeHCH₃, Li₂SeHNO₂, or any combination thereof.

Aspects of the disclosure are drawn towards a battery comprising the solid-state electrolyte of described herein.

Other objects and advantages of this invention will become readily apparent from the ensuing description.

### BRIEF DESCRIPTION OF THE FIGURES

FIG. 1 shows non-limiting, exemplary unit cell and crystal structure. Li₃ONO₃ unit cell with cubic crystal structure obtained by VASP simulation shown on the left side of figure. Li₃OCl unit cell with cubic crystal structure generated by CrystalMaker® using CIF file data retrieved from the Materials Project for Li₃ClO (mp-985585) from database version v2022.10.28 [30-32].

FIG. 2 shows non-limiting, exemplary XRD spectra. Comparison between Powder XRD patterns of precursors (Li₂O and LiNO₃), simulated XRD patterns of Li₃ONO₃, and experimentally acquired XRD pattern of Li₃ONO₃.

FIG. 3 shows non-limiting, exemplary XRD spectra. Experimental XRD pattern of Li₃ONO₃ indexed according to the closest matching 20 peak in the simulated XRD patterns of Li₃ONO₃.

FIG. 4 shows a non-limiting, exemplary Nyquist plot and circuit diagram. Experimentally obtained Nyquist plot for Li₃ONO₃ with curve fitting based on the equivalent circuit shown above the plot, where each inflection point is labeled in resistance and frequency due to the separate contributions from bulk (b) and grain boundary (gb).

FIG. 5 shows non-limiting, exemplary glow discharge optical emission spectroscopy (GD-OES) of Li₃ONO₃ film.

FIG. 6 shows non-limiting, exemplary photographs of thin films. Li₃ONO₃ and Li₃OCl thin films prepared by ball milling and spin coating inside glovebox. a) Li₃ONO₃ thin film before exposure to air b) Li₃OCl thin film before exposure to air c) Li₃ONO₃ thin film after 25 min exposure to air with 10% RH d) Li₃OCl thin film after 25 min exposure to air with 10% RH.

FIG. 7 shows non-limiting, exemplary photographs of films are varying solvent and spin rates and optical microscopy images.

FIG. 8 shows non-limiting, exemplary graphs of impedance measurements of sintered (Panel A) and unsintered (Panel B) materials.

FIG. 9 shows a non-limiting, exemplary unsintered fracture testing stress/strain curve.

FIG. 10 shows a non-limiting, exemplary profilometry of film thickness.

FIG. 11 shows non-limiting, exemplary photographs of fracture testing samples.

FIG. 12 shows non-limiting, exemplary XRD spectra comparing Li₃ONO₃ ball-milled precursors and spin coated thin films.

### DETAILED DESCRIPTION OF THE INVENTION

Aspects described herein provide antiperovskite compositions, methods of making antiperovskite compositions, and methods of use thereof.

Detailed descriptions of one or more embodiments are provided herein. It is to be understood, however, that the present invention can be embodied in various forms. Therefore, specific details disclosed herein are not to be interpreted as limiting, but rather as a basis for the claims and as a representative basis for teaching one skilled in the art to employ the present invention in any appropriate manner.

The singular forms “a”, “an” and “the” include plural reference unless the context clearly dictates otherwise. The use of the word “a” or “an” when used in conjunction with the term “comprising” in the claims and/or the specification can mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

As used herein, the term “about” can refer to approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

As used herein, the term “substantially the same” or “substantially” can refer to variability typical for a particular method is taken into account.

The terms “sufficient” and “effective”, as used interchangeably herein, can refer to an amount (e.g., mass, volume, dosage, concentration, and/or time period) needed to achieve one or more desired result(s).

Before explaining at least one embodiment of the disclosure in detail, it is to be understood that the disclosure is not necessarily limited in its application to the details set forth in the following description or exemplified by the examples. The disclosure is capable of other embodiments or of being practiced or carried out in various ways. Other compositions, compounds, methods, features, and advantages of the present disclosure will be or become apparent to one having ordinary skill in the art upon examination of the following drawings, detailed description, and examples. All such additional compositions, compounds, methods, features, and advantages can be included within this description, and be within the scope of the present disclosure.

Aspects of the invention are drawn towards new halogen-free Li-rich anti-perovskite (LiRAP) compositions, materials, and applications of the same. In embodiments, the LiRAPs described herein do not contain a halogen, leading to improved properties such as decreased hygroscopicity, milder reaction conditions, and the ability to produced thinly processed materials.

As used herein, the term “antiperovskite” can refer to a composition having a crystal structure similar to a conventional perovskite but with the unit cell having the positive and negative species reversed. In a perovskite structure, the unit cell is face centered cubic. The negative atoms can sit on the face centers and positive ions sit in the corners. Additionally, there can be a third type of atom, a cation, in the center of the cubic unit cell. In an antiperovskite structure, the locations of cations and anions are reversed. In the antiperovskite structure, of the type described herein, oxygen or sulfur atoms, for example, reside at centers of the unit cell, non-halogen atoms sit at corners of the unit cell, and lithium ions reside in the face centers of the unit cell. As used herein, the term halogen can refer to F, Cl, Br, or I.

According to various embodiments, the LiRAP composition can be a composition according to Formula (I): Li₃BA. In embodiments, A can be a non-halogen anion selected from the group consisting of NO₃⁻¹, NO₂⁻¹, NH₂⁻¹, CH₃⁻¹, or any combination thereof. In embodiments B can be an anion selected from the group consisting of O⁻², Se⁻², Te⁻², S⁻², or any combination thereof.

In embodiments, the LiRAP composition can be a composition according to Formula (II): Li₂BA. In embodiments, A can be a non-halogen anion selected from the group consisting of NO₃⁻¹, NO₂⁻¹, NH₂⁻¹, CH₃⁻¹, or any combination thereof. In embodiments, B can be an anion selected from the group consisting of OH⁻, SeH⁻, or SH⁻.

The LiRAP composition can be formed from constituent non-halogen lithium salts. Examples of the non-halogen lithium salt comprise lithium methoxide (CH₃LiO), lithium ethoxide (CH₃CH₂OLi), lithium isopropoxide (CH₃)₂CHOLi, lithium tertbutoxide (CH₃)₃COLi, lithium hydroxide (LiOH), lithium acetate (C₂H₃LiO₂), lithium carbonate (Li₂CO₃), lithium oxide (Li₂O), lithium sulfanide (LiSH), lithium sulfide (Li₂S), lithium nitrate (LiNO₃), lithium nitrite (LiNO₂), or lithium amide (LiNH₂), or any combination thereof.

In embodiments, the non-halogen LiRAP composition can comprise Li₃ONO₃, Li₃SNO₃, Li₃ONO₂, Li₃ONH₂, Li₃SNO₃, Li₂OHNO₃, Li₂OHNO₂, Li₂OHNH₂, Li₂SHNO₃, Li₂SHNO₂, Li₂SHNH₂, Li₃SeNO₃, Li₃SeNO₂, Li₃SeNH₂, Li₃SeCH₃, Li₂SeHNO₃, Li₂SeHNH₂, Li₂SeHCH₃, Li₂SeHNO₂, or any combination thereof.

In embodiments, the non-halogen LiRAP composition consists of Formula III: Li₍₃₋ₓ₎Y(Hₓ)NX_{z} or Li₍₃₋ₓ₎Y(Hₓ)CH₃ wherein Y=O, S, or Se; X=O or H; x=0-1, z=2-3.

In some embodiments, the halogen LiRAP composition can further comprise one or more additional dopants. As used herein, the term dopant can refer to an impurity, or an additive element, ion, chemical, or material, which is present in an amount less than the amount of the additive dopant species to alter the properties of the species.

In embodiments, Formula I and Formula II can be variable.

In embodiments, these dopants can be halogen or non-halogen dopants. For example, non-halogen dopants can comprise cations selected from the group consisting of Na, K, Rb, Cs, Mg, Ca, Sr, Ta, Mn, Co, Fe, Ba, or any combination thereof. These non-halogen dopants can dope on the Li site. In embodiments, the halogen dopants can comprise anions selected from the group consisting of F, Cl, Br, I, or any combination thereof. These halogen dopants can dope on the A or B sites or both A and B sites of the Li₃AB structure.

In embodiments, the dopants can be present in about 0.0001 mol. % to about 1.0 mol. %. For example, the dopants can present in about less than about 0.0001 mol. %, about 0.0001 mol. %, about 0.00025 mol. %, about 0.0005 mol. %, about 0.00075 mol. %, about 0.001 mol. %, about 0.0025 mol. %, about 0.005 mol. %, about 0.0075 mol. %, about 0.01 mol. %, about 0.025 mol. %, about 0.050 mol. %, about 0.075 mol. %, about 0.1 mol. %, about 0.25 mol %, about 0.5 mol. %, about 0.75 mol. %, about 1.0 mol. %, about 2.5 mol. %, or greater than about 2.5 mol. %.

In embodiments, the non-halogen LiRAP composition can be used to produce a non-halogen LiRAP material. The LiRAP material can be produced by solution deposition or any other suitable method. When a layer of LiRAP material is formed by solution deposition, a solution containing the precursor salts can be formed. The concentration of the lithium precursors in solution can vary depending on the application. This concentration can be tuned by one of ordinary skill in the art.

Aspects of the disclosure are drawn towards a method of producing a halogen-free, solid state electrolyte, the method comprising: dissolving lithium precursors in a solvent to form a solution; applying the solution onto a substrate; and drying the solution, thereby producing a halogen-free, solid-state electrolyte. In embodiments, the lithium precursors are selected from the group consisting of lithium hydroxide (LiOH), lithium acetate (C₂H₃LiO₂), lithium carbonate (Li₂CO₃), lithium oxide (Li₂O), lithium sulfanide (LiSH), lithium sulfide (Li₂S), lithium nitrate (LiNO₃), lithium nitrite (LiNO₂), or lithium amide (LiNH₂), lithium methoxide (LiCH₃₀), lithium ethoxide (C₂H₅LiO), lithium isopropoxide (C₃H₇LiO), lithium tert-butoxide (LiOC(CH₃)₃, or any combination thereof. For example, the lithium precursors are lithium nitrate (LiNO₃) and lithium oxide (Li₂O).

In embodiments, the solid state-electrolyte can be a film. In embodiments, the film has a thickness of about 10 nm to about 1 mm.

The solution can also contain a solvent or co-solvents. For example, water, methanol, 1-propanol, propionic acid, isopropanol, butanol, dichloromethane, ethylene glycol, and ethanol are some of the solvents in which the lithium salts are soluble. For other lithium salts, butanol, dimethyl sulfoxide (DMSO), and/or dimethylformamide (DMF) can be used as a solvent. In embodiments, any know solvent or combinations of solvents can be used herein. For example, the solvent is ethanol.

In some embodiments, the method does not require sintering. In other embodiments, the method further comprising sintering. In some embodiments, the method is performed in an open-air environment. In some embodiments, the method is performed in a glovebox.

In embodiments the LiRAP composition can be applied to a substrate as a thin film. Methods of deposition are known in the art and can include, but are not limited to, spin coating, blade coating, gravure coating, spray coating, slot-die coating, tape casting, chemical vapor deposition, hot pressing, sputtering, thermal evaporation, or dip coating and can be used in batch or continuous roll-to-roll coating processes.

In embodiments the film can have a thickness of about 10 nm to about 1 mm. For example, the thickness can be less than about 10 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 80 nm, about 90 nm, about 100 nm, about 125 nm, about 150 nm, about 175 nm, about 200 nm, about 225 nm, about 250 nm, about 275 nm, about 300 nm, about 325 nm, about 350 nm, about 375 nm, about 400 nm, about 425 nm, about 450 nm, about 475 nm, about 500 nm, about 525 nm, about 550 nm, about 575 nm, about 600 nm, about 650 nm, about 700 nm, about 750 nm, about 800 nm, about 850 nm, about 900 nm, about 1000 nm, about 1100 nm, about 1200 nm, about 1300 nm, about 1400 nm, about 1500 nm, about 1600 nm, about 1700 nm, about 1800 nm, about 1900 nm, about 2000 nm, about 2250 nm, about 2500 nm, about 2750 nm, about 3000 nm, about 3250 nm, about 3500 nm, about 3750 nm, about 4000 nm, about 4250 nm, about 4500 nm, about 4750 nm, about 5000 nm, about 5250 nm, about 5500 nm, about 5750 nm, about 6000 nm, about 6250 nm, about 6500 nm, about 6750 nm, about 7000 nm, about 7250 nm, about 7500 nm, about 7750 nm, about 8000 nm, about 8250 nm, about 8500 nm, about 8750 nm, about 9000 nm, about 9250 nm, about 9500 nm, about 9750 nm, about 0.01 mm, about 0.025 mm, about 0.05 mm, about 0.075 mm, about 0.1 mm, about 0.25 mm, about 0.5 mm, about 0.75 nm, about 1.0 mm, or greater than about 1.0 mm.

In embodiments, the composition can be phase-stable at room temperature. As used herein, the term room temperature can refer to about 15° C. to about 26° C.

Once prepared, the solution can be applied to a substrate. For example, the substrate can comprise a copper, stainless steel, aluminum, lithium, or any combination thereof.

The solution can be coated on the substrate using, for example, a doctor blade or other suitable coating method. In some embodiments, the film is coated onto an anode layer, a cathode layer, or both. In some embodiments, the substrate can be a component of a battery such as the anode, cathode, or separator layer. The deposited substrate can then be dried.

The dried substrate can be dried at a temperature ranging from about 50° C. to about 350° C., for a period ranging from about 1 minute to about 1 day, to form a LiRAP material. For example, the substrate can be dried at a temperature of less than about 30° C., about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., about 300° C., about 310° C., about 320° C., about 330° C., about 340° C., about 350° C., or greater than 350° C.

In embodiments the substrate can be dried for less than about 1 min, about 2.5 min, about 5 min, about 7.5 min, about 10 min, about 12.5 min, about 15 min, about 17.5 min, about 20 min, about 25 min, about 30 min, about 35 min, about 40 min, about 45 min, about 50 min, about 55 min, about 60 min, about 90 min, about 2 hours, about 2.5 hours, about 3 hours, about 3.5 hours, about 4 hours, about 4.5 hours, about 5 hours, about 5.5 hours, about 6 hours, about 6.5 hours, about 7 hours, about 7.5 hours, about 8 hours, about 8.5 hours, about 9 hours, about 10 hours, about 11 hours, about 12 hours, about 15 hours, about 17 hours, about 20 hours, about 24 hours, about 1.5 days, about 2 days, about 3 days, or greater than 3 days.

In embodiments, the composition can have an ion conductivity of above about 1.0×10⁻⁴ S/cm, about 1.0×10⁻⁴ S/cm, about 0.9×10⁻⁴ S/cm, about 0.8×10⁻⁴ S/cm, about 0.7×10⁻⁴ S/cm, about 0.6×10⁻⁴ S/cm, about 0.5×10⁻⁴ S/cm, about 0.4×10⁻⁴ S/cm, about 0.3×10⁻⁴ S/cm, about 0.2×10⁻⁴ S/cm, about 1×10⁻⁵ S/cm, about 0.9×10⁻⁵ S/cm, about 0.8×10⁻⁵ S/cm, about 0.7×10⁻⁵ S/cm, about 0.6×10⁻⁵ S/cm, about 0.5×10⁻⁵ S/cm, about 0.4×10⁻⁵ S/cm, about 0.3×10⁻⁵ S/cm, about 0.2×10⁵, S/cm, about 1.0×10⁻⁶ S/cm, about 4.07×10⁻⁶ S/cm, about 3.12×10⁻⁶ S/cm, about 1.15×10⁻⁷ S/cm, or below about 1.15×10⁻⁷ S/cm.

The substrate can then be assembled with other components.

The LiRAP material described herein can be ionically conductive and electrically insulating. In embodiments, the LiRAP material can be included as a layer, coating, and/or matrix. In embodiments, the LiRAP material can be incorporated into a working electrode of an EC device. For example, the LiRAP material can form a core-shell structure with the working electrode material, with particles of the working electrode being encapsulated by the LiRAP material. In other embodiments, the LiRAP material can form a matrix around particles of the working electrode material. In some embodiments, the LiRAP material can be used as an electrolyte layer in place of a conventional electrolyte. In some embodiments, the LiRAP material described herein can be incorporated into an anode layer. In some embodiments, the LiRAP material described herein can be incorporated into a cathode layer. In some embodiments, the LiRAP material can be incorporated into a separator layer.

In some embodiments, the LiRAP material is incorporated into an ion exchange membrane. For example, the LiRAP can be used in memristor applications.

In embodiments, the solid-state electrolyte system disclosed herein can be used in Li-based batteries such as Li-air, LiFePO₄, LiMn₂O₄, LiMnO₂, lithium-sulfur, LiCoO₂, LiNiₓMn_{y}Co_{z}O₂ (where x, y, z=≤1 and where x+y+z=1), or LiNiₓCo_{y}Al_{z} (where x, y, z=≤1 and where x+y+z=1) and metal doped variations thereof. More specifically, cathodes LiNiₓMn_{y}Co_{z}O₂ or LiNiₓCo_{y}Al_{z} can be used where the Ni content represented by x is in the range of about 0.3-0.95, or in the range of about 0.55-0.9, or in the range of about 0.6-0.8.

The SSE system disclosed herein can also be used in Na or Ca-based batteries. Metal doped and/or carbon coated cathode variations thereof of any of the Li, Na or Ca-based batteries can be combined with the SSE system disclosed herein. The anode can be a metal such as one of lithium metal, pure silicon, indium metal, and aluminum metal. The anode can be mixed metal, metal-sulfide, metal-phosphide, metal-oxide, or carbon-based which can comprise graphene, nanotubes or other structured carbon. The SSE disclosed herein can be used in cylindrical, button, coin, pouch, or prismatic battery cells.

### EXAMPLES

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

### a Halide-Free Li-Rich Antiperovskite Solid State Electrolyte

### Abstract

Described herein is a halide-free lithium rich antiperovskite (LiRAP) solid-state electrolyte with the use of nitrate (NO₃⁻) in the X-site (Li₃ONO₃). Simulations and crystal structure calculations demonstrate that the structure of Li₃ONO₃ is cubic and phase-stable at room temperature. A sintering-free, binder-free, solution-processing route of stoichiometric amounts of LiNO₃ and Li₂O is used to create the Li₃ONO₃ phase which is in good agreement with the predicted cubic structure. A room-temperature ionic conductivity >1 μS/cm is demonstrated for Li₃ONO₃ thin films. A uniform composition throughout the thickness is observed using elemental depth profiling with no hydrogen or carbon, indicating a lack of hydroxide or carbonate phase. Furthermore, the Li₃ONO₃ films are significantly more moisture stable than halide based Li₃OCl counterparts.

### INTRODUCTION

Over the past decade, advances in lithium-ion battery technologies have enabled monumental shifts in industries from consumer electronics to electric vehicles to grid-scale energy storage [1]. However, the increased use of lithium-ion batteries has raised concerns about the safety of the technology, with flammability being a particular concern in cases such as the Boeing 787 Dreamliner and the Samsung Galaxy A21 cell phone [2]. These increasing safety concerns, combined with a plateauing performance of lithium-ion battery technology, has led researchers to pursue solid-state battery technologies that leverage a solid electrolyte to reduce safety risks while increasing energy density [3].

Thin film solid-state electrolytes have been notable in this field of research because thin films are smaller than the standard bulk solid-state electrolytes, and therefore can have higher ion conductivity and lower resistance [4]. Additionally, thin films are easier to manufacture than bulk solid-state electrolytes and can be scaled up to mass production.

Over the past decade, there has been interest in solid electrolytes featuring lithium-rich anti-perovskite (LiRAP) crystal structures. This attention is driven by their distinct advantages, such as respectable ionic conductivity, enhanced mechanical compliance, and the potential for easy synthesis and rapid processability [5,6]. These benefits can stem from the high symmetry of the LiRAP cubic crystal structure and its lower melting point. LiRAP structures can have a chemical formula of A₃BX, with A representing a small cation like lithium, B being a central anion such as oxide, and X being another anion like chloride. Most LiRAP solid electrolytes, as reported in the literature, belong to the Pm3̅m space group, characterized by a cubic crystal lattice. However, certain LiRAP variants deviate from cubic symmetry, leading to the formation of tetragonal or orthorhombic crystal lattices [6,7]. LiRAP solid electrolytes lack sufficient moisture stability [11,12]. The hygroscopicity observed in halide LiRAPs can arise from the hygroscopic nature of the lithium halide precursors commonly used in their synthesis, as halides have been shown to be moisture unstable in a variety of chemistries [8,9].

Described herein, we replace the halide ion in the LiRAP structure with a nitrate ion to offer advantages for moisture resistance and processability [10]. Produce a new lithium rich halide-free LiRAP with the base chemical formula Li₃ONO₃. Synthesized and processed using cost-effective methods, Li₃ONO₃ aims to enhance the cost-effectiveness and production potential of existing LiRAP technologies on a larger scale toward manufacturability.

### Results

Li-Rich Anti-Perovskite Li₃ONO₃ Phase: Predicted Thermodynamic Stability

Predicting phase stability and structural distortion is important for controlling the physical properties of all crystalline materials. Nearly a century ago, Goldschmidt proposed the “no-rattling” principle to explain the formability of perovskite crystal structures [11]. According to this principle, “the number of anions surrounding a cation tends to be as large as possible, subject to the condition that all anions touch the cation” [12]. Goldschmidt based this assumption on the notion that the perovskite crystal structure comprises anions and cations behaving as rigid, hard spheres [12].

In a conventional perovskite with the chemical formula ABX₃, the Goldschmidt tolerance factor, denoted as t, is expressed as,

$$t = \frac{( {r}_{A} + {r}_{X} )}{\sqrt{2} ( {r}_{B} + {r}_{X} )} ,$$

where r_{A} is the anion radius while r_{B}, and r_{X} are the cation radii [13]. For an ideal cubic perovskite, t equals 1; deviations from this value can introduce distortions to the cubic unit cell [14,15]. The structural and thermodynamic phase instability resulting from the distortion of the unit cell depends on two key factors: i) distortion in the B-cation octahedron formed by X anions and ii) distortion in the A-cation cuboctahedron formed by X anions [16-18].

To address the resulting thermodynamic phase instability, an additional geometric constraint was incorporated, the octahedral factor (u) [19,20]. This factor is defined as the ratio of the B-cation and X-anion ionic radii, expressed as

$$μ = \frac{( {r}_{B} )}{( {r}_{A} )} .$$

This, in addition to the widely used Goldschmidt tolerance factor (t), serves as an extra geometrical constraint [21]. In LiRAP anti-perovskite structures, the parameters “t” and “μ” undergo modifications as the cation Li replaces the anion in the perovskite structure, resulting in updated expressions:

$$t = \frac{( {r}_{A} + {r}_{X} )}{\sqrt{2} ( {r}_{B} + {r}_{A} )} and μ = \frac{( {r}_{B} )}{( {r}_{A} )} ⌊ 6 , 7 , 22 , 23 ⌋ .$$

As shown herein, the values of t and μ for Li₃ONO₃ determined using ionic radii reported in literature are 0.89 and 0.71 respectively. In comparison to Li₃OCl, the calculated t for Li₃ONO₃ is 6% higher, while the μ is 8% higher than that of Li₃OCl. This is promising, as the most successfully synthesized LiRAP compositions lie in the range 0.75<t<0.9 [7]. Similarly, a reasonable u value larger than 0.414 has been commonly proposed for a stable cation octahedron surrounding the anions in cubic structure. Thus, both t and u lie in the range suitable for a stable Li₃ONO₃ phase with cubic structure [6,24].

Crystal Structure of Li₃ONO₃ Phase: Ab initio Calculations vs Experimental Results

First-principles DFT calculations were performed to investigate the formation energy, and the likely sites for cation, Li⁺ and anions O²⁻ and [NO₃]⁻ in a cubic crystal structure.

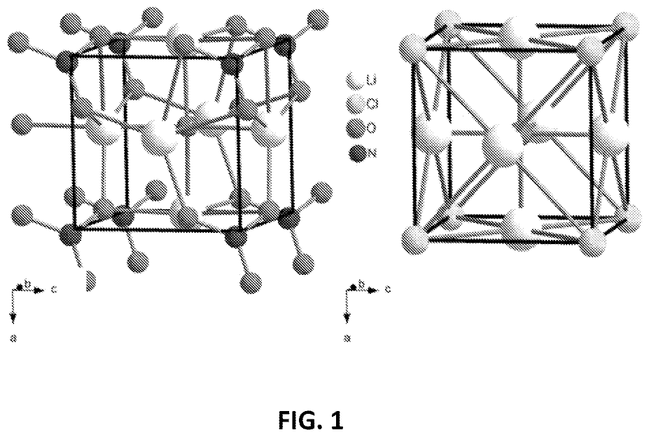

The Li₃ONO₃ cubic unit cell shown in FIG. 1 has a lattice constant, a=4.1482 Å, which exceeds the Li₃OCl lattice constant, a=3.9083 Å. CIF file for the Li₃ONO₃ cubic unit cell was used to generate powder diffraction pattern for Li₃ONO₃ phase using CrystalMaker® and CrystalDiffract® software. The values of “t” and “μ” for Li₃ONO₃, derived from crystal radii within the simulated unit cell, are 0.86 and 0.73, respectively. When compared to the corresponding values for Li₃OCl, calculated using crystal radii obtained from CIF file reported in literature, the calculated “1” for Li₃ONO₃ is 3% higher, and the “μ” is 4% higher than that of Li₃OCl. Thus, the calculated “t” and “μ” values for Li₃ONO₃ are closer to t and u values for Li₃OCl when crystal radii are used for the calculations instead of ionic radii.

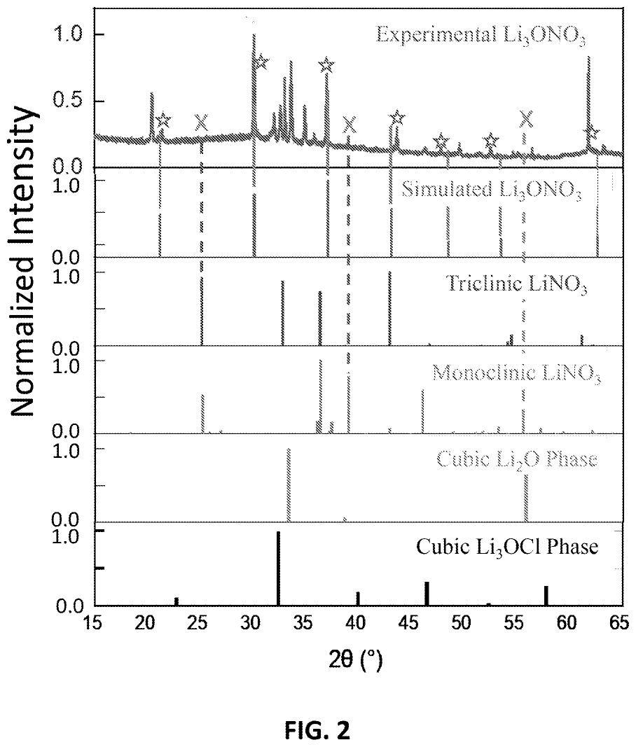

FIG. 2 shows the comparison of powder diffraction pattern obtained for Li₃ONO₃ thin film deposited on silicon with its precursors, Li₂O and LiNO₃ as well as the powder diffraction pattern generated for simulated Li₃ONO₃ cubic unit cell. Even though there is slight variability, the powder diffraction pattern for the spin coated Li₃ONO₃ reasonably matches with the highest intensity 2θ peaks generated for simulated Li₃ONO₃ unit cell. In addition, it is worth noting that both precursors, LiNO₃ and Li₂O have converted into a new phase, as their respective 20 reflections are not present in the spin coated Li₃ONO₃.

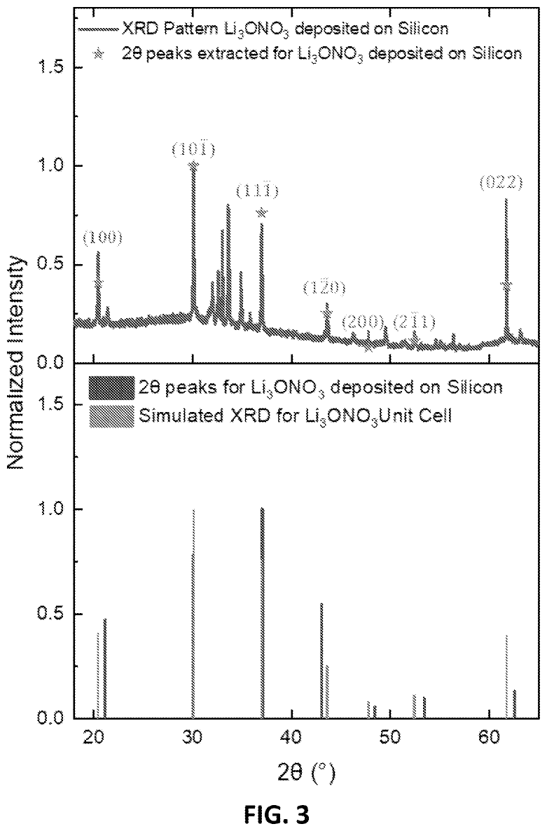

FIG. 3 provides a detailed examination of the powder XRD pattern of synthesized Li₃ONO₃ in comparison with the simulated XRD patterns of cubic Li₃ONO₃ unit cell model. At certain locations, the 2θ reflections of the synthesized Li₃ONO₃ deviate by up to (±1°) from the simulated pattern, can or cannot be attributed to mixture of phases, cubic within the deposited Li₃ONO₃ film on silicon. These shifts can also be explained by the presence of a non-cubic Li₃ONO₃ phase. However, overall, the 2θ peak positions, intensity, of the experimentally obtained Li₃ONO₃ closely align with the highest intensity 2θ reflections from the simulated Li₃ONO₃ XRD pattern, indicating a reasonable match. There are still reflections from spin coated Li₃ONO₃ film on silicon and the exact composition and structure of the new phase has not been fully identified. The spectrum does exhibit matches with hydroxide phases (LiOH and LiOH·H₂O); however, no hydrogen is detected upon elemental depth profiling. Since the XRD was performed in air, some of these phases can have occurred during transport and measurement of the film.

### Electrochemical Impedance Spectroscopy (EIS)

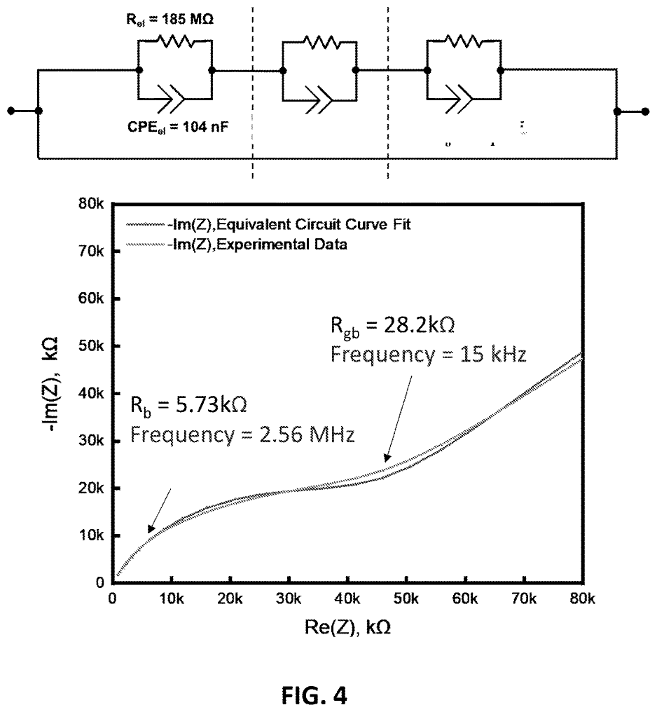

FIG. 4 shows a Nyquist plot constructed from impedance data acquired in the frequency range of 10 Hz to 10 MHz for the Li₃ONO₃ film. The method for acquiring impedance data using a pair of in-plane electrodes and the criteria for selecting equivalent circuit and ionic conductivity calculations is described in detail in our work [25]. An equivalent circuit shown above Nyquist plot in FIG. 4 was used to fit impedance semicircles to extract the bulk and grain boundary impedances and to estimate electrode contact resistance. Overall, the ionic conductivity of the Li₃ONO₃ film is 3.12*10⁻⁶ S/cm at room temperature. This is markedly higher than reported bulk LiRAP conductivities at room temperature, although thin films have been produced with higher conductivities using Li₃OCl (Lu et al., Antiperovskite Li₃OCl Superionic Conductor Films for Solid-State Li-Ion Batteries, Advanced Science Vol. 3, Issue 3, 2016). Note that the thin film was produced with pulsed laser deposition using a high vacuum process that is considerably lower throughput and higher capital expenditure than our fully solution-processed and sintering-free method.

### Glow Discharge-Optical Emission Spectroscopy (GD-OES)

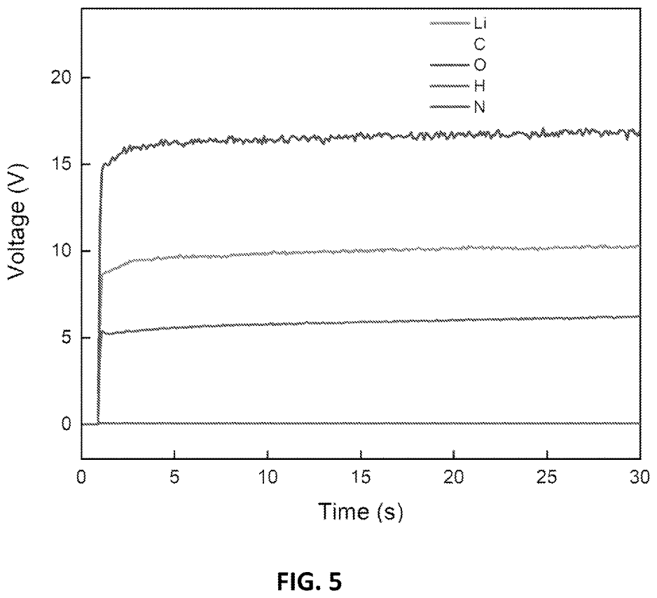

FIG. 5 shows the GD-OES profile for Li, O, H and C obtained on Li₃ONO₃ film performed in open-air. Li and O ratio is uniform throughout the depth. Despite being measured in ambient, contaminants such as C and H are hardly present, indicating that undesired side phases such as LiOH and Li₂CO₃ are not detectable. Furthermore, the elemental composition is uniform throughout the thickness of the film. The ratio of the Li, N, and O signals are also in good agreement with the predicted stoichiometry of Li₃ONO₃.

Moisture Stability of Li₃ONO₃ vs Li₃OCl Phase

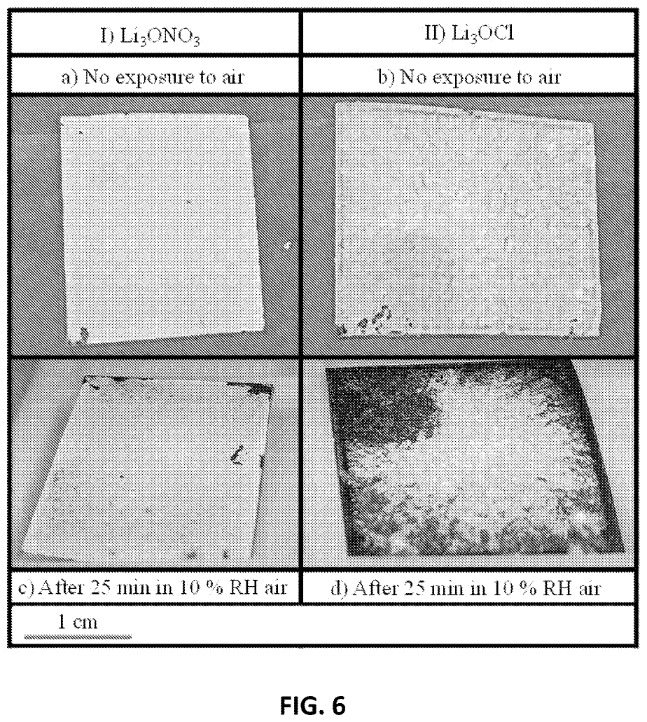

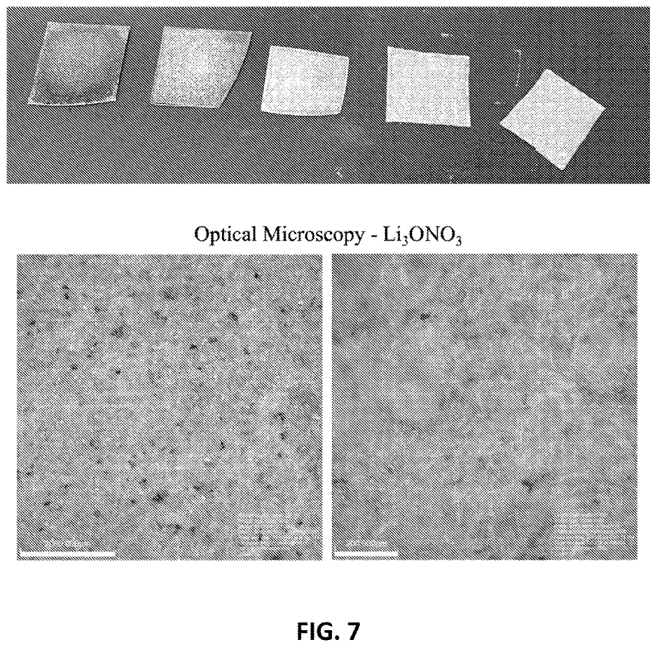

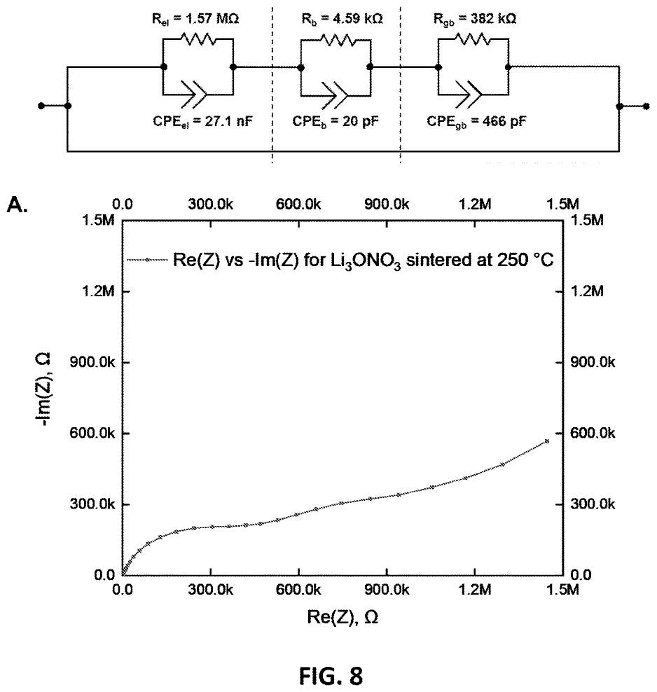

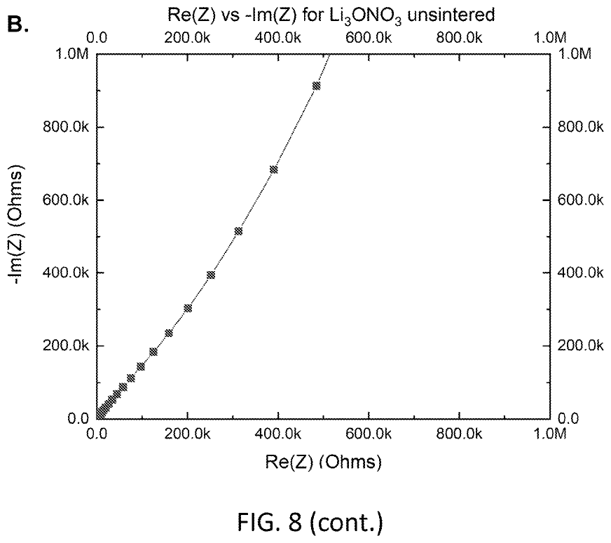

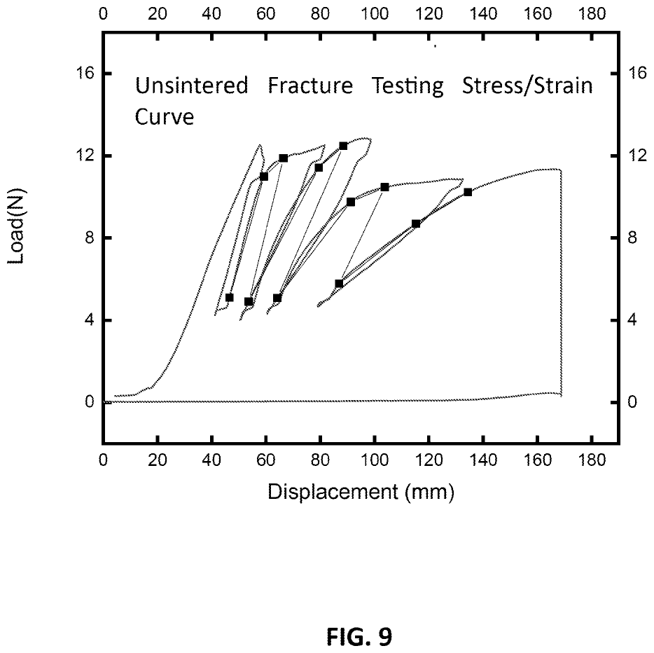

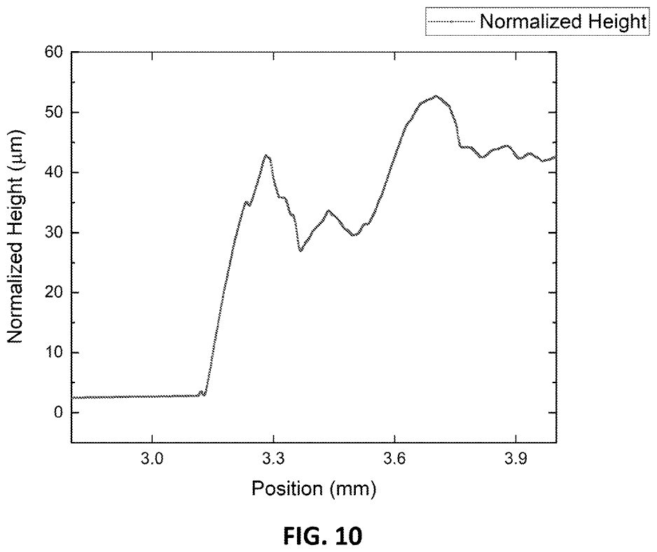

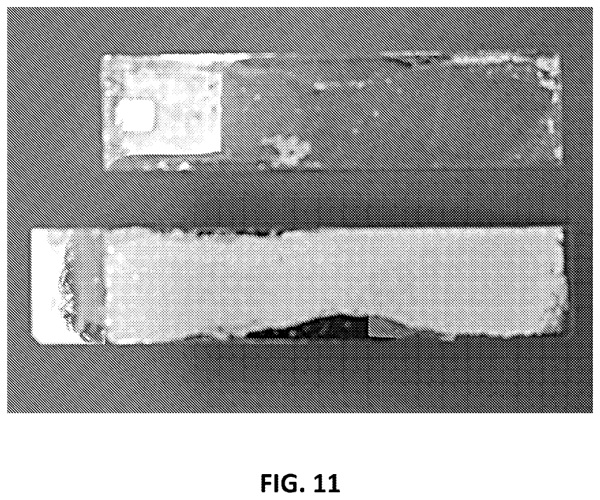

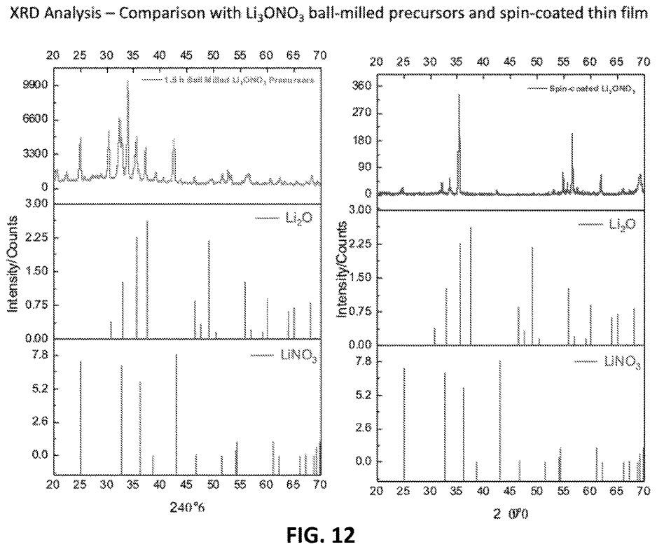

Both perovskite and LiRAP, with ABX₃ and A₃BX stoichiometry, respectively (where X represents the halide anion), exhibit poor moisture stability [26,27]. Incorporating NO₃ ions into halide perovskites, such as MAPBI₃, to form MAPbBr₃₋ₓ(NO₃)ₓ, can enhance moisture stability [10]. In FIG. 6, indicates that Li₃ONO₃, featuring a non-halide [NO₃] anion, displays superior moisture resistance compared to Li₃OCl, which contains a halide Cl-anion, when exposed to 10% relative humidity air for 25 minutes inside of a humidity-controlled chamber regulated with dry air and measured with a hygrometer. The degradation area of the Li₃OCl film was approximately 35% of the original area, while that of Li₃ONO₃ was only 3%, indicating a substantial enhancement in moisture stability compared to Li₃OCl. The poor moisture stability of Li₃OCl can be attributed to its strong attraction to water molecules in the atmosphere, potentially leading to the formation of an amorphous LiCl-xH₂O in Li₃OCl [27].

### CONCLUSION

Described herein we indicate Li₃ONO₃ is a cost-effective, high throughput, and more commercially viable form to produce LiRAP technologies to reach a larger scale. The slurry cast process without any sintering and produced entirely at low temperatures <150° C. demonstrates compatibility with direct deposition on a range of current collectors and cathode materials. The moisture tolerance eases restrictions on processing and overcomes some of the largest concerns regarding halide-based antiperovskite phase stability. We can study the interfacial ion behavior at the anode and cathode interfaces as well as improving on the phase through rapid sintering methods.

### Materials and Methods

The Li₃ONO₃ precursors for this work were LiNO₃ (99.0%, Sigma-Aldrich), and Li₂O (99.0%, Sigma-Aldrich). These precursors were weighed and mixed stoichiometrically (1:1, LiNO₃ and Li₂O molar ratio) to obtain Li₃ONO₃. The Li₃ONO₃ precursor solution was prepared by dissolving 2 grams of precursor powder in 3 mL of ethanol and carrying out wet ball milling inside a nitrogen-filled glovebox. The resultant solution was deposited onto a silicon substrate through spin coating (1000 rpm for 10s) within the same glovebox environment.

### Processing Equipment

Ball milling was done with a Retsch ball miller (MM200, agate grinding jar with 7 mm agate grinding balls). The Li₃ONO₃ precursor ink was deposited using spin coating (Laurell).

### Characterization Equipment

### XRD: Powder Diffraction Analysis was Performed Using a Powder Diffractometer (Malvern PANalytical Aeris Research Edition).

EIS: Potentiostatic Electrochemical Impedance Spectroscopy (EIS) measurements were performed in an in-plane configuration using ion blocking pencil graphite electrodes with a surface area of 1 cm² and a parallel spacing of 1 cm placed on Li₃ONO₃ thin film. The complex impedance response of the in-plane configuration was measured using a Paios measurement system (Fluxim AG) by varying the frequency from 10 Hz to 10 MHz for an applied voltage with an amplitude of 50 mV. Data from EIS measurements were fitted with simulated response of equivalent circuits using Fluxim's Characterization Suite software.

Glow Discharge Optical Emission Spectroscopy (GD-OES): Horiba GD-Profiler 2 Glow Discharge Optical Emission Spectrometer was used to obtain Li, O, N, C and H elemental profiles of Li₃ONO₃ film. RF Power and frequency used for producing glow discharge plasma are 20 W and 686 Pa.

Preparation of Li₃ONO₃ Precursor Suspension and Synthesis of Li₃ONO₃ Thin Film

### Ball Milling

Wet ball milling was used to mix precursor powders LiNO₃ and Li₂O dispersed in ethanol. Ball milling was done with a Retsch ball miller (MM200, agate grinding jar with 7 mm agate grinding balls). Wet ball milling was chosen over dry ball milling because it was expected to reduce the size of the powder mixture (<10 μm) with less contamination and surface oxidation [25].

### Spin Coating in Glovebox

Li₃ONO₃ films are deposited using spin coating (Laurell) in a glovebox environment. The precursor ink was statically dispensed on a silicon substrate and rotated at 1000 rpm for 30 seconds. Following the rotating step, the spin coated silicon substrate was baked for 5 to 10 minutes on a hot plate set to 100° C. to evaporate residual solvent and allow thin film formation.

### REFERENCES CITED HEREIN

Korthauer, R. Lithium-Ion Batteries: Basics and Applications; Springer, 2018; ISBN 3662530716.
2. Lisbona, D.; Snee, T. A Review of Hazards Associated with Primary Lithium and Lithium-Ion Batteries. Process safety and environmental protection 2011, 89, 434-442.
3. Evarts, E. C. Lithium Batteries: To the Limits of Lithium. Nature 2015, 526, S93-S95.
4. Xia, H.; Wang, H. L.; Xiao, W.; Lai, M. O.; Lu, L. Thin Film Li Electrolytes for All-Solid-State Micro-Batteries. International Journal of Surface Science and Engineering 2009, 3, 23-43.
5. Feng, W.; Zhu, L.; Dong, X.; Wang, Y.; Xia, Y.; Wang, F. Enhanced Moisture Stability of Lithium-Rich Antiperovskites for Sustainable All-Solid-State Lithium Batteries. Advanced Materials 2023, 35, 2210365.
6. Xia, W.; Zhao, Y.; Zhao, F.; Adair, K.; Zhao, R.; Li, S.; Zou, R.; Zhao, Y.; Sun, X. Antiperovskite Electrolytes for Solid-State Batteries. Chem Rev 2022, 122, 3763-3819.
7. Dawson, J. A.; Famprikis, T.; Johnston, K. E. Anti-Perovskites for Solid-State Batteries: Recent Developments, Current Challenges and Future Prospects. J Mater Chem A Mater 2021, 9, 18746-18772.
8. Xu, J.; Pollard, T. P.; Yang, C.; Dandu, N. K.; Tan, S.; Zhou, J.; Wang, J.; He, X.; Zhang, X.; Li, A.-M. Lithium Halide Cathodes for Li Metal Batteries. Joule 2023, 7, 83-94.
9. Sohr, J.; Schmidt, H.; Voigt, W. Higher Hydrates of Lithium Chloride, Lithium Bromide and Lithium Iodide. Acta Crystallogr C Struct Chem 2018, 74, 194-202.
10. Nim, G. K.; Bansal, P.; Kar, P. Nitrate Ion-Incorporated Stable Perovskite Nanocrystals by a Solvent-Free Mechanochemical Reaction. ACS Omega 2019, 4, 15678-15683.
11. Goldschmidt, V. M. Die Gesetze Der Krystallochemie. Naturwissenschaften 1926, 14, 477-485, doi: 10.1007/BF01507527.
12. Filip, M. R.; Giustino, F. The Geometric Blueprint of Perovskites. Proceedings of the National Academy of Sciences 2018, 115, 5397-5402.
13. Filip, M. R.; Giustino, F. The Geometric Blueprint of Perovskites. Proceedings of the National Academy of Sciences 2018, 115, 5397-5402.
14. Li, C.; Lu, X.; Ding, W.; Feng, L.; Gao, Y.; Guo, Z. Formability of Abx3 (X=f, Cl, Br, i) Halide Perovskites. Acta Crystallogr B 2008, 64, 702-707.
15. Bartel, C. J.; Sutton, C.; Goldsmith, B. R.; Ouyang, R.; Musgrave, C. B.; Ghiringhelli, L. M.; Scheffler, M. New Tolerance Factor to Predict the Stability of Perovskite Oxides and Halides. Sci Adv 2019, 5, eaav0693.
16. Travis, W.; Glover, E. N. K.; Bronstein, H.; Scanlon, D. O.; Palgrave, R. G. On the Application of the Tolerance Factor to Inorganic and Hybrid Halide Perovskites: A Revised System. Chem Sci 2016, 7, 4548-4556.
17. Fukunaga, O.; Fujita, T. The Relation between Ionic Radii and Cell Volumes in the Perovskite Compounds. J Solid State Chem 1973, 8, 331-338.
18. Goodenough, J. B.; Longo, M. 3.1. 2.1 Tolerance Factor: 3.1. 2 The Influence of Relative Ionic Sizes. Part A 1970, 132-134.
19. Li, Z.; Xu, Q.; Sun, Q.; Hou, Z.; Yin, W. Thermodynamic Stability Landscape of Halide Double Perovskites via High-throughput Computing and Machine Learning. Adv Funct Mater 2019, 29, 1807280.
20. Young, S. D.; Chen, J.; Sun, W.; Goldsmith, B. R.; Pilania, G. Thermodynamic Stability and Anion Ordering of Perovskite Oxynitrides. Chemistry of Materials 2023, 35, 5975-5987.
21. Jerpoth, S. S.; Iannello, J.; Aboagye, E. A.; Yenkie, K. M. Computer-Aided Synthesis of Cost-Effective Perovskite Crystals: An Emerging Alternative to Silicon Solar Cells. Clean Technol Environ Policy 2020, 22, 1187-1198.
22. Zheng, J.; Perry, B.; Wu, Y. Antiperovskite Superionic Conductors: A Critical Review. ACS Materials Au 2021, 1, 92-106.
23. Deng, Z.; Ni, D.; Chen, D.; Bian, Y.; Li, S.; Wang, Z.; Zhao, Y. Anti-perovskite Materials for Energy Storage Batteries. InfoMat 2022, 4, e12252.
24. Li, X.; Zhang, Y.; Kang, W.; Yan, Z.; Shen, Y.; Huo, J. Anti-Perovskite Nitrides and Oxides: Properties and Preparation. Comput Mater Sci 2023, 225, 112188.
25. Sahal, M.; Molloy, J.; Narayanan, V. R.; Ladani, L.; Lu, X.; Rolston, N. Robust and Manufacturable Lithium Lanthanum Titanate-Based Solid-State Electrolyte Thin Films Deposited in Open Air. ACS Omega 2023, 8, 28651-28662.
26. Agresti, A.; Pescetelli, S.; Cinà, L.; Konios, D.; Kakavelakis, G.; Kymakis, E.; Carlo, A. Di Efficiency and Stability Enhancement in Perovskite Solar Cells by Inserting Lithium-neutralized Graphene Oxide as Electron Transporting Layer. Adv Funct Mater 2016, 26, 2686-2694.
27. Niu, G.; Guo, X.; Wang, L. Review of Recent Progress in Chemical Stability of Perovskite Solar Cells. J Mater Chem A Mater 2015, 3, 8970-8980.
28. Jung, H. J.; Sohn, Y.; Sung, H. G.; Hyun, H. S.; Shin, W. G. Physicochemical Properties of Ball Milled Boron Particles: Dry vs. Wet Ball Milling Process. Powder Technol 2015, 269, 548-553.
29. Miao, C.; Hamad, W. Y. Controlling Lignin Particle Size for Polymer Blend Applications. J Appl Polym Sci 2017, 134.
30. The Materials Project Materials Data on Li₃CIO by Materials Project.
31. Jain, A.; Ong, S. P.; Hautier, G.; Chen, W.; Richards, W. D.; Dacek, S.; Cholia, S.; Gunter, D.; Skinner, D.; Ceder, G. Commentary: The Materials Project: A Materials Genome Approach to Accelerating Materials Innovation. APL Mater 2013, 1.
32. CrystalMaker®: A Crystal and Molecular Structures Program for Mac and Windows. CrystalMaker Software Ltd, Oxford, England (Www.Crystalmaker.Com).

### Example 2

### Halide-Free Anti Perovskite Solid Electrolyte

The thermodynamic stability of the suggested halide-free anti-perovskite compounds, which include lithium ions and have the chemical formula X₃BA, can be predicted by using two key geometric constraints: i) Tolerance Factor,

$$t = \frac{( {r}_{A} + {r}_{X} )}{\sqrt{2} ( {r}_{B} + {r}_{X} )}$$

### and ii) Octahedral Factor,

$$μ = \frac{( {r}_{X} )}{( {r}_{B} )} .$$

In these equations, r_{X}, represents the radius of the cation, while r_{A} and r_{B} represent the radius of the anions.

For a stable perovskite structure to form, the values of two key parameters can fall within specific ranges: (i) Tolerance Factor,

$$t = \frac{( {r}_{A} + {r}_{X} )}{\sqrt{2} ( {r}_{B} + {r}_{X} )}$$

### and ii) Octahedral Factor

$$μ = \frac{( {r}_{X} )}{( {r}_{B} )} ,$$

can be close to or greater than 0.41.

TABLE 1
Shows established halide anti-perovskite composition values
and indicated halide free anti-perovskite composition values.

| | | | | | | | | | |
|---|---|---|---|---|---|---|---|---|---|
| | Chemical | | | | | | | | |
| | Formula | | | | | | | Tolerance | Octahedral |
| # | (X₃BA) | X | B | A | r_{X}(Å) | r_{B}(Å) | r_{A}(Å) | Factor, t | Factor, μ |

Established halide anti-perovskite composition (as a comparison)

| | | | | | | | | | |
|---|---|---|---|---|---|---|---|---|---|
| 1 | Li₃OC1 | Li⁺¹ | O⁻² | C1⁻¹ | 0.76 | 1.40 | 1.81 | 0.84 | 0.54 |

Suggested halide free anti-perovskite compositions

| | | | | | | | | | |
|---|---|---|---|---|---|---|---|---|---|
| 1 | Li₃SNO₃ | Li⁺¹ | S⁻² | [NO₃]⁻¹ | 0.76 | 1.84 | 2.64 | 0.92 | 0.41 |
| 2 | Li₃ONO₃ | Li⁺¹ | O⁻² | [NO₃]⁻¹ | 0.76 | 1.40 | 2.64 | 1.11 | 0.54 |
| 3 | Li₃ONO₂ | Li⁺² | O⁻³ | [NO₂]⁻¹ | 0.76 | 1.40 | 2.16 | 0.96 | 0.54 |
| 4 | Li₃ONH₂ | Li⁺² | O⁻³ | [NH₂]⁻¹ | 0.76 | 1.40 | 1.71 | 0.81 | 0.54 |
| 5 | Li₃SCH₃ | Li⁺¹ | S⁻² | [CH₃]⁻¹ | 0.76 | 1.84 | 2.60 | 0.91 | 0.41 |

Table 1 shows tolerance factors and octahedral factors for, without wishing to be bound by theory, phase stability of various halide-free antiperovskite compositions.

### REFERENCES

Tolerance and octahedral factor, doi.org/10.1021/acs.chemrev.1c00594
[NO₃]⁻¹ radius, doi.org/10.1039/DOTA07110B
[NO₂]⁻¹ radius based on, doi.org/10.17188/1195055
[NH₂]⁻¹ and [CH₃]⁻¹ radii, doi.org/10.1021/acs.chemrev.1c00594
S⁻² radius, abulafia.mt.ic.ac.uk/shannon/ptable.php

### Example 3

### a Halide-Free Material for Li-Rich Antiperovskite Solid-State Materials

### Abstract

Aspects of the invention are drawn towards uses of a new anti-perovskite material (Li₃ONO₃) as a solid-state electrolyte for scalable low-cost processing of battery manufacturing. The new material requires less processing and is compatible with ultra-high throughput processing compared to other existing solid-state electrolyte materials.

### Introduction

This disclosure can improve the functionality and manufacturability of solid-state electrolytes so that solid-state batteries can be more easily produced. Currently, lithium-ion batteries use flammable and bulky liquid electrolytes, reducing energy density and safety of battery cells. Additionally, other solid-state electrolytes have required very high-cost, low throughput processing to manufacture. This work is in the field of renewable energy materials, manufacturing, and sustainability to expand on low-cost domestic battery technology.

### Non-Limiting Description

Anti-perovskites are a class of materials that have been explored as candidates for solid-state electrolytes (SSEs). These materials, such as lithium oxygen bromide, can require several high-cost processes to form a functional SSE, which can involve high-temperature sintering as well as special atmospheric chambers to prevent water vapor from interacting with the material. An aspect of the disclosure is the use of lithium oxygen nitrate, a material within the class of anti-perovskite materials, as a solid-state electrolyte. This material can be formed by dissolving lithium oxide and lithium nitrate in ethanol in a 1:1 molar ratio, without environmental chambers or heating. This solution can then be applied as a thin film onto a silicon substrate via spin coating or blade coating, and then the film is dried at low temperatures (<150° C.) to remove the ethanol solvent. No high-temperature sintering is required. This creates a film of lithium oxygen nitrate with an ionic conductivity in the range of 10\hat{ }-5 S/m. This is higher than commercialized SSE technology of solid-state electrolytes that are based on sputter deposited lithium phosphorous oxynitride (LiPON), which also is a much slower throughput process. This new material is a better candidate for solid-state electrolytes due to its relatively high ionic conductivity and relatively low manufacturing costs.

### Non-Limiting Summary

This technology addresses several challenges that need to be overcome within the field of solid-state electrolytes, particularly with regards to ionic conductivity and manufacturing cost:

### Material Processing

Solution Processing: This material can be formed by simple solution processing, rather than a complex, expensive manufacturing process.
Open Air: The material can be created in an open-air environment, unlike typical solid-state electrolyte. Despite the presence of moisture during synthesis, the material performs competitively or superior to other methods, although once formed it does need to be kept in a moisture-free environment to prevent degradation.
Low-cost production: This material does not require high-temperature sintering to produce a stable electrolyte, greatly reducing manufacturing time and cost.
Ion conductivity: This material has a comparable ionic conductivity to most other SSEs, around 10\hat{ }-5 S/m. Combined with the significantly easier manufacturing process, this material is better for applications for SSEs.

### Non-Limiting Unique Aspects of Disclosure

A new aspect is the material itself. This is the first use of this material as a solid-state electrolyte, and there are no other examples of it being used. It is also processed in a way that is unique (using no sintering or high-temperature processing) and therefore is compatible with a range of underlying materials and substrates where almost all solid-state electrolytes cannot be used. The exception is LiPON, for which deposition can occur at low temperatures, but it requires expensive and slow vacuum equipment and has significantly lower ionic conductivity as an amorphous material.

### Non-Limiting Advantages of Disclosure

SSEs are better than liquid electrolytes due to their increased energy density and safety due to no flammable components. This material is advantageous to other solid-state electrolytes and to liquid electrolytes because it maintains a high ionic conductivity while reducing manufacturing costs compared to other SSEs. There is lower cost because production does not require high-cost sintering or special atmospheric chambers to process the precursors to form the final material. This material is also both mechanically robust and highly flexible.

### Non-Limiting Commercial Embodiments

This disclosure can be used in the development of the next generation solid state battery technology. This can include high energy density batteries for consumer electronics to electric vehicles. The lightweight and extremely low-cost process enables applications in UAVs, drones, satellites, trucking (providing energy for refrigeration), residential, commercial, and eventually grid-scale energy storage.

The solid-state electrolyte system disclosed herein can be used in Li-based batteries such as Li-air, LiFePO₄, Li₂MnO₄, LiMnO₂, lithium-sulfur, LiCoO₂, LiNiₓMn_{y}Co_{z}O₂ (where x, y, z=≤1 and where x+y+z=1), or LiNiₓCo_{y}Al_{z} (where x, y, z=<1 and where x+y+z=1) and metal doped variations thereof. More specifically, cathodes LiNiₓMn_{y}Co_{z}O₂ or LiNiₓCo_{y}Al_{z} can be used where the Ni content represented by x is in the range of about 0.3-0.95, or in the range of about 0.55-0.9, or in the range of about 0.6-0.8.

The SSE system disclosed herein can also be used in Na or Ca-based batteries. Metal doped and/or carbon coated cathode variations thereof of any of the Li, Na or Ca-based batteries can be combined with the SSE system disclosed herein. The anode can be a metal such as one of lithium metal, pure silicon, indium metal, and aluminum metal. The anode can be mixed metal, metal-sulfide, metal-phosphide, metal-oxide, or carbon-based which can comprise graphene, nanotubes or other structured carbon. The SSE disclosed herein can be used in cylindrical, button, coin, pouch, or prismatic battery cells.

### References Cited Herein

1. “Lithium-rich antiperovskite compound, lithium secondary battery electrolyte comprising same, and lithium secondary battery comprising same” U.S. Pat. No. 10,680,282B2
2. “Electrochromic device including lithium-rich anti-perovskite material” U.S. Pat. No. 11,299,429B2

### Example 4

### A Halide-Free Material for Li-Rich Antiperovskite Solid-State Materials

### Non-Limiting Technology Summary

The technology is a new anti-perovskite material for use as an electrolyte in solid-state batteries. The material is Li₃ONO₃ and requires far less processing and is compatible with ultra-high throughput methods for use in scalable, low-cost processing of battery manufacturing. Traditionally, anti-perovskites require expensive processing such as atmospheric chambers and high temperature sintering to form the electrolyte. The Li₃ONO₃ can be formed using less expensive solution methods in the open air and requires mild heating conditions at <150° C. to dry the film. The films have a high ionic conductivity in the range of 10-5 S/m which is comparable to conventional solid-state electrolytes. The Li₃ONO₃ films are also mechanically robust and flexible.

### Non-Limiting Features of Interest

Thin films of Li₃ONO₃ synthesized in the open air.
Developed inexpensive production process compared to traditional anti-perovskite electrolytes.

A synthetic method has been developed. Thin films of Li₃ONO₃ have been assembled and tested. The ionic conductivity of the Li₃ONO₃ thin films has been measured.

### Example 5

### Characterizing Anti-Perovskite Films for Solid-State Electrolytes in Batteries

Described herein are anti-perovskite materials that can be manufactured at a reasonably low cost with sufficient ion conductivity to function as a solid-state electrolyte.

### Non-Limiting Exemplary Method:

Solution processing of precursors to form lithium oxygen nitrate (Li₃ONO₃)
Spin coating and blade coating
Initially no high-temperature sintering, only mild baking (manufacturing advantage)
PMMA coating or nitrogen glovebox to combat moisture sensitivity
XRD, PAIOS, profilometry, optical microscopy, fracture testing (double cantilever)

### Non-Limiting, Exemplary Results:

Conductivity Values: 4.07×10⁻⁶ S/cm sintered and 1.15×10⁻⁷ S/cm unsintered
Fracture Test: 5.18+/−1.22 J/m²
Visually uniform, dense films
Relatively simple manufacturing process

### References Cited in this Example

1. Springer-Verlag GmbH Germany, part of Spring Nature 2018 R. Korthauer (ed.), Lithium-Ion Batteries: Basics and Applications, https://doi.org/10.1007/978-3-662-53071-9_2
2. Lisbona, D., &amp; Snee, T. (2011). A review of hazards associated with primary lithium and lithium-ion batteries. Process Safety and Environmental Protection, 89 (6), 434-442. https://doi.org/10.1016/j.psep.2011.06.022
3. Evarts, E. Lithium batteries: To the limits of lithium. Nature 526, S93-S95 (2015). https://doi.org/10.1038/526S93a
4. Wei Xia, Yang Zhao, Feipeng Zhao, Keegan Adair, Ruo Zhao, Shuai Li, Ruqiang Zou, Yusheng Zhao, and Xueliang Sun. Chemical Reviews 2022 122 (3), 3763-3819, DOI: 10.1021/acs.chemrev.1c00594
5. Eslamian, M. Inorganic and Organic Solution-Processed Thin Film Devices. Nano-Micro Lett. 9, 3 (2017). https://doi.org/10.1007/s40820-016-0106-4

Those skilled in the art will recognize, or be able to ascertain, using no more than routine experimentation, numerous equivalents to the specific substances and procedures described herein. Such equivalents are considered to be within the scope of this invention and are covered by the following claims.

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed is:

1. A halogen-free, lithium-rich antiperovskite composition (LiRAP) of Formula (I):
Li₃BA (Formula I)
wherein B is an anion selected from the group consisting of O⁻², Se⁻², or S⁻²; and
A is an anion selected from the group consisting of NO₃⁻¹, NO₂⁻¹, CH₃⁻¹, or NH₂⁻¹; or Formula (II):
Li₂BA (Formula II)
wherein B is an anion selected from the group consisting of OH⁻, SeH⁻¹, and SH⁻; and
A is an anion selected from the group consisting of NO₃⁻¹, NO₂⁻¹, CH₃⁻¹, or NH₂⁻¹.

2. The composition of claim 1, wherein the composition comprises an ion conductivity of above about 1.0×10⁻⁴ S/cm, about 1.0×10⁻⁴ S/cm, about 0.9×10⁻⁴ S/cm, about 0.8×10⁻⁴ S/cm, about 0.7×10⁻⁴ S/cm, about 0.6×10⁻⁴ S/cm, about 0.5×10⁻⁴ S/cm, about 0.4×10⁻⁴ S/cm, about 0.3×10⁻⁴ S/cm, about 0.2×10⁻⁴ S/cm, about 1×10⁻⁵ S/cm, about 0.9×10⁻⁵ S/cm, about 0.8×10⁻⁵ S/cm, about 0.7×10⁻⁵ S/cm, about 0.6×10⁻⁵ S/cm, about 0.5×10⁻⁵ S/cm, about 0.4×10⁻⁵ S/cm, about 0.3×10⁻⁵ S/cm, about 0.2×10⁻⁵, S/cm, about 1.0×10⁻⁶ S/cm, about 4.07×10⁻⁶ S/cm, about 3.12×10⁻⁶ S/cm, about 1.15×10⁻⁷ S/cm, or below about 1.15×10⁻⁷ S/cm.

3. The composition of claim 1, wherein the composition is selected from the group consisting of Li₃ONO₃, Li₃SNO₃, Li₃ONO₂, Li₃ONH₂, Li₃SNO₃, Li₂OHNO₃, Li₂OHNO₂, Li₂OHNH₂, Li₂SHNO₃, Li₂SHNO₂, Li₂SHNH₂, Li₃SeNO₃, Li₃SeNO₂, Li₃SeNH₂, Li₃SeCH₃, Li₂SeHNO₃, Li₂SeHNH₂, Li₂SeHCH₃, Li₂SeHNO₂, or any combination thereof.

4. The composition of claim 1, wherein the composition is phase-stable at room temperature.

5. The composition of claim 1, wherein the composition comprises one or more dopants.

6. A method of producing a halogen-free, solid-state electrolyte, the method comprising:
dissolving lithium precursors in a solvent to form a solution;
applying the solution onto a substrate; and
drying the solution, thereby producing a halogen-free, solid-state electrolyte.

7. The method of claim 6, wherein the lithium precursors are selected from the group consisting of lithium hydroxide (LiOH), lithium acetate (C₂H₃LiO₂), lithium carbonate (Li₂CO₃), lithium oxide (Li₂O), lithium sulfanide (LiSH), lithium sulfide (Li₂S), lithium nitrate (LiNO₃), lithium nitrite (LiNO₂), or lithium amide (LiNH₂), lithium methoxide (LiCH₃O), lithium ethoxide (C₂H₅LiO), lithium isopropoxide (C₃H₇LiO), lithium tert-butoxide (LiOC(CH₃)₃, or any combination thereof.

8. The method of claim 7, wherein the lithium precursors are lithium nitrate (LiNO₃) and lithium oxide (Li₂O).

9. The method of claim 6, wherein the solid state-electrolyte is a film.

10. The method of claim 9, wherein the film has a thickness of about 10 nm to about 1 mm.

11. The method of claim 6, wherein the solvent comprises ethanol.

12. The method of claim 6, wherein the substrate comprises a silicon wafer, copper, stainless steel, aluminum, lithium, or any combination thereof.

13. The method of claim 12, wherein the film is coated onto an anode layer, a cathode layer, or both.

14. The method of claim 6, wherein drying the film comprises subjecting the film to a temperature of about 70° C. to about 350° C.

15. The method of claim 6, wherein the method does not require sintering.

16. The method of claim 6, further comprising sintering the solid-state electrolyte.

17. The method of claim 6, wherein the method is performed in an open-air environment or in a glovebox.

18. The method of claim 6, wherein the solid-state electrolyte comprises an ionic conductivity of above about 1.0×10⁻⁴ S/cm, about 1.0×10⁻⁴ S/cm, about 0.9×10⁻⁴ S/cm, about 0.8×10⁻⁴ S/cm, about 0.7×10⁻⁴ S/cm, about 0.6×10⁻⁴ S/cm, about 0.5×10⁻⁴ S/cm, about 0.4×10⁻⁴ S/cm, about 0.3×10⁻⁴ S/cm, about 0.2×10⁻⁴ S/cm, about 1×10⁻⁵ S/cm, about 0.9×10⁻⁵ S/cm, about 0.8×10⁻⁵ S/cm, about 0.7×10⁻⁵ S/cm, about 0.6×10⁻⁵ S/cm, about 0.5×10⁻⁵ S/cm, about 0.4×10⁻⁵ S/cm, about 0.3×10⁻⁵ S/cm, about 0.2×10⁻⁵, S/cm, about 1.0×10⁻⁶ S/cm, about 4.07×10⁻⁶ S/cm, about 3.12×10⁻⁶ S/cm, about 1.15×10⁻⁷ S/cm, or below about 1.15×10⁻⁷ S/cm.

19. The method of claim 6, wherein the solid-state electrolyte is selected from the group consisting of Li₃ONO₃, Li₃SNO₃, Li₃ONO₂, Li₃ONH₂, Li₃SNO₃, Li₂OHNO₃, Li₂OHNO₂, Li₂OHNH₂, Li₂SHNO₃, Li₂SHNO₂, Li₂SHNH₂, Li₃SeNO₃, Li₃SeNO₂, Li₃SeNH₂, Li₃SeCH₃, Li₂SeHNO₃, Li₂SeHNH₂, Li₂SeHCH₃, Li₂SeHNO₂, or any combination thereof.

20. A battery comprising the solid-state electrolyte of claim 6.
